(19) United States
(12) Patent Application Publication
(10) Pub. No.: US 2009/0296951 A1
(43) Pub. Date: Dec. 3, 2009

(54) TAP VOLUME CONTROL FOR BUTTONLESS HEADSET

(75) Inventor: Ido DE HAAN, Assen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/129,752

(22) Filed: May 30, 2008

(51) Int. Cl. H04R 1/10

(52) U.S. Cl. 381/74

(57) ABSTRACT

A headset for an electronic device includes an audio output device including a left ear piece and a right ear piece, and a plurality of transducers each operable to provide a signal corresponding to at least one of motion or vibration of at least a portion of the headset. One transducer of the plurality of transducers is associated with the left ear piece and another transducer of the plurality of transducers is associated with the right ear piece. The headset further includes circuitry operatively coupled to the plurality of transducers, wherein the circuitry is configured to generate a control signal for use by the headset or the electronic device based on the respective signals.

### TECHNICAL FIELD OF THE INVENTION

The present invention relates generally to electronic devices and, more particularly, to an apparatus and method for controlling operation of an electronic device via a buttonless accessory of the electronic device.

### DESCRIPTION OF THE RELATED ART

Electronic devices, such as portable communication devices, have evolved from voice-only electronic devices to multi-functional electronic devices. For example, portable communication devices, such as mobile telephones, may now function as electronic organizers, digital cameras, audio applications (e.g., MP3 players), video applications (e.g., video players), video game terminals, etc. Moreover, portable communication devices are not only used for voice communications, but they also are used in a variety of other forms (e.g., in instant messaging applications, sharing photographs, gaining access to information on the Internet, etc).

Due in part to the popularity of portable communication devices, many accessories have been developed for use therewith. These accessories, such as headsets and the like, have various features that may be adjusted to suit each individual's preferences. For example, when using a headset a user will typically adjust the headset's volume output to suit their preference. Such adjustment is typically performed via buttons or the like located on the headset, wherein the volume may be increased or decreased, for example, by pressing the button corresponding to the desired operation.

For aesthetic reasons and/or due to size reductions, some recently developed accessories do not include buttons. When using such accessories, user controls (e.g., volume adjustments, etc.) are intended to be activated through the electronic device (e.g., the phone, mp3 player, etc.). This can present problems, however, as some electronic devices may not include user control functionality for the accessory. As a result, these newer accessories may not be compatible with all electronic devices.

### SUMMARY

A device and method in accordance with the present invention enables accessories, such as headsets and the like, to provide user input functionality without the use of physical buttons. To provide user input functionality, the accessory includes one transducer, and preferably at least two transducers, that can generate a signal when the accessory is touched, tapped, rotated, etc. This signal then can be interpreted by the accessory, and a command can be issued based on the specific sequence of signals and/or the timing of the signals. Preferably, the transducer(s) comprise MEMS-based accelerometers or the like.

For example, a headset may include one transducer in each ear piece (e.g., a left transducer in the left ear piece, and a right transducer in the right ear piece), and control circuitry operatively coupled to the transducers. Further, stored in memory may be a plurality of signal combinations and corresponding commands (e.g., a single signal from the right transducer corresponds to a volume increase request, and a single signal from the left transducer corresponds to a volume decrease request). Then, as a user taps the left or right ear piece, the transducer generates a corresponding signal, which is provided to the control circuitry. The control circuitry receives the signal and compares it to the signals stored in memory. Based on the comparison, the control circuitry equates the signal with a specific command and acts accordingly (e.g., a single tap on the right ear piece results in a volume increase).

Additionally, other control operations are possible. For example, tapping both the left and right ear pieces simultaneously may place the headset in mute mode. Additionally, call accept and reject features may be implemented in the accessory in accordance with the invention. Such additional commands may be equated with multiple taps of one ear piece (e.g., two taps on the right ear piece may be equated to a call accept, and two taps on the left ear piece may be equated to a call reject).

According to one aspect of the invention, there is provided a headset for an electronic device. The headset includes: an audio output device including a left ear piece and a right ear piece; a plurality of transducers each operable to provide a signal corresponding to at least one of motion or vibration of at least a portion of the headset, wherein one transducer of the plurality of transducers is associated with the left ear piece and another transducer of the plurality of transducers is associated with the right ear piece; and circuitry operatively coupled to the plurality of transducers, wherein the circuitry is configured to generate a control signal for use by the headset or the electronic device based on the respective signals.

According to one aspect of the invention, the headset includes a memory; a plurality of different signals stored in the memory; and a plurality of different commands stored in the memory, wherein each of the plurality of different signals is associated with one of the plurality of commands.

According to one aspect of the invention, the circuitry is operative to determine if the respective signals correspond to any of the plurality of signals stored in memory, and to generate the control signal based on the command associated with the corresponding signal.

According to one aspect of the invention, each of the plurality of transducers comprises i) a first transducer for generating a first signal corresponding to motion of the portion of the headset and ii) a second transducer for generating a second signal corresponding to vibration of the portion of the headset.

According to one aspect of the invention, the circuitry includes signal processing circuitry operatively coupled to the first and second transducer, wherein the signal processing circuitry is configured to i) determine intended motion from the first signal; ii) determine intended vibration from the second signal; and iii) generate the control signal when the intended motion and intended vibration correspond to one another.

According to one aspect of the invention, wherein the headset is a buttonless headset.

According to one aspect of the invention, at least one of the transducers comprises an accelerometer.

According to one aspect of the invention, the headset includes a wireless transceiver operative to communicate the control signal between the accessory and the electronic device.

According to one aspect of the invention, the headset includes a signal processing circuit operatively coupled to each transducer of the plurality of transducers, wherein the signal processing circuit is configured to determine from each signal at least one of intended motion or intended vibration of the portion of the accessory.

According to one aspect of the invention, the signals correspond to acceleration and/or deceleration of the portion of the accessory along at least one predetermined axis.

According to one aspect of the invention, the signal processing circuit comprising a signal conditioning circuit to filter out signals that do not meet predetermined criteria.

According to one aspect of the invention, the signal processing circuit is operative to provide a motion and/or vibration signal indicative of duration of the motion and/or vibration, amplitude of the motion and/or vibration, and/or frequency of the motion and/or vibration.

According to one aspect of the invention, at least one of the transducers is operable to detect at least one of acceleration, position, or rotation of the portion of the accessory.

According to one aspect of the invention, there is provided a system for providing audio to a user, comprising the headset as described herein; and an electronic device for use with the headset.

According to one aspect of the invention, there is provided a method for controlling an electronic device from an accessory, said accessory including at least one transducer operable to provide a first signal indicative of at least one of motion or vibration of at least a portion of said accessory. The method includes: storing in memory a plurality of predefined signals and corresponding commands; comparing the first signal from the at least one transducer with the predefined signals stored in memory; and upon the first signal corresponding to one predefined signal of the plurality of predefined signals, executing the command associated with the corresponding predefined signal.

According to one aspect of the invention, the at least one transducer comprises a first transducer operative to detect motion of the portion of the accessory, and a second transducer operative to detect vibration of the portion of the accessory, further comprising executing the command when a first signal from the first transducer and a second signal from the second transducer are determined to be in agreement.

According to one aspect of the invention, the method includes tapping on a portion of the accessory to generate the first signal.

According to one aspect of the invention, executing the command includes executing at least one of a volume increase, a volume decrease, a mute, a call accept or a call end.

According to one aspect of the invention, executing the command includes communicating the command associated with the corresponding predefined signal to the electronic device via a wired or wireless interface.

According to one aspect of the invention, the method includes performing signal conditioning on the first signal to filter out signals that do not meet a predetermined criteria.

According to one aspect of the invention, there is provided an accessory for an electronic device, the accessory including: a memory; a plurality of different signals stored in the memory; a plurality of different commands stored in the memory, wherein each of the plurality of different signals is associated with one of the plurality of commands; at least one transducer operable to provide a first signal corresponding to at least one of motion or vibration of at least a portion of the accessory; and circuitry operatively coupled to the transducer, wherein the circuitry is configured to generate a control signal for use by the accessory or the electronic device based on the first signal.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a headset as an exemplary accessory in accordance with an embodiment of the present invention.

FIG. 2 is a block diagram illustrating an accelerometer as an exemplary transducer in an ear piece of the headset of FIG. 1.

FIG. 3 is a schematic block diagram of the relevant portions of the headset of FIG. 1 in accordance with an embodiment of the present invention.

FIGS. 4, 5 and 6 are, respectively, schematic illustrations of exemplary transducers providing for motion and/or vibration detection based on threshold, amplitude, or frequency.

FIG. 7 is a block diagram illustrating exemplary steps for controlling an accessory based on signals from the transducer.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

The term “accessory” includes portable devices for use with electronic equipment. Portable devices, as used herein, include wired and wireless headsets, wired and wireless microphones, power adapters, game controllers, and the like.

In the present application, embodiments of the invention are described primarily in the context of a headset for a mobile telephone. However, it will be appreciated that the invention is not intended to be limited to the context of a headset or mobile telephone and may relate to any type of appropriate accessories (e.g., game controllers, power adapters/chargers, etc.) and/or electronic equipment (e.g., media player, a gaming device, a computer, etc.).

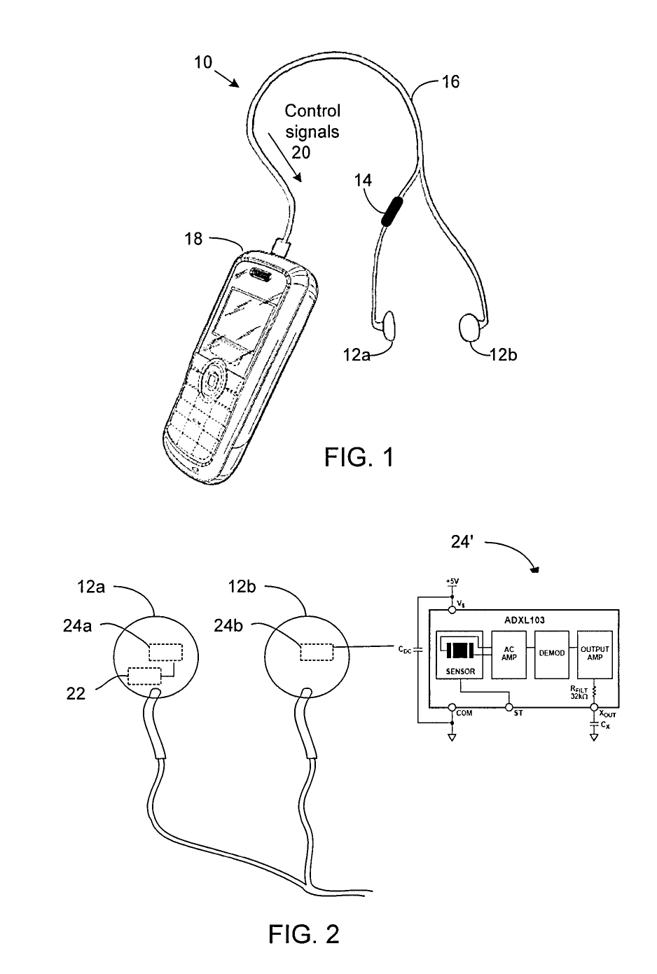

Referring initially to FIG. 1, there is shown an exemplary wired headset 10 in accordance with an embodiment of the invention. The headset 10 includes left and right ear pieces 12a and 12b (collectively referred to as ear pieces 12), and a microphone 14. As will be appreciated, the ear pieces 12 and/or microphone 14 may take various shapes depending on the specific design of the headset. For example, instead of ear pieces that fit within a portion of the ear (e.g., ear buds), the headset may use ear pieces that fit over the entire ear. Similarly, the microphone 14 may be formed as an extension from one ear piece, or included in a common enclosure with one ear piece. Conductors 16 couple the headset 10 to an electronic device 18, such as a mobile phone, for example, which in turn receives control signals 20 therefrom. The control signals (which are described in more detail below) may comprise, for example, a volume increase or decrease signal, mute signal, call accept signal, call end signal, etc.

It is noted that while a wired headset 10 is shown in FIG. 1, the headset may be a wireless headset that communicates to the electronic device 18 via a short range radio interface, such as a Bluetooth radio interface, for example. Further, while both ear pieces 12 and a microphone 14 are shown, the headset 10 need not include both. For example, the headset 10 may only include ear pieces 12, without a microphone.

With further reference to FIG. 2, there is shown a simple schematic diagram of an exemplary embodiment of the headset 10. Within the left ear piece 12a is a control circuit 22 and a transducer 24a, wherein the control circuit 22 is electrically coupled to the transducer 24a. The right ear piece 12b includes only a transducer 24b, which is electrically coupled (not shown) to the control circuit 22 of the left ear piece 12a. As will be appreciated, the control circuit 22 may reside in the right ear piece 12b (instead of the left ear piece 12a). In another embodiment, both ear pieces 12 may have their own control circuit.

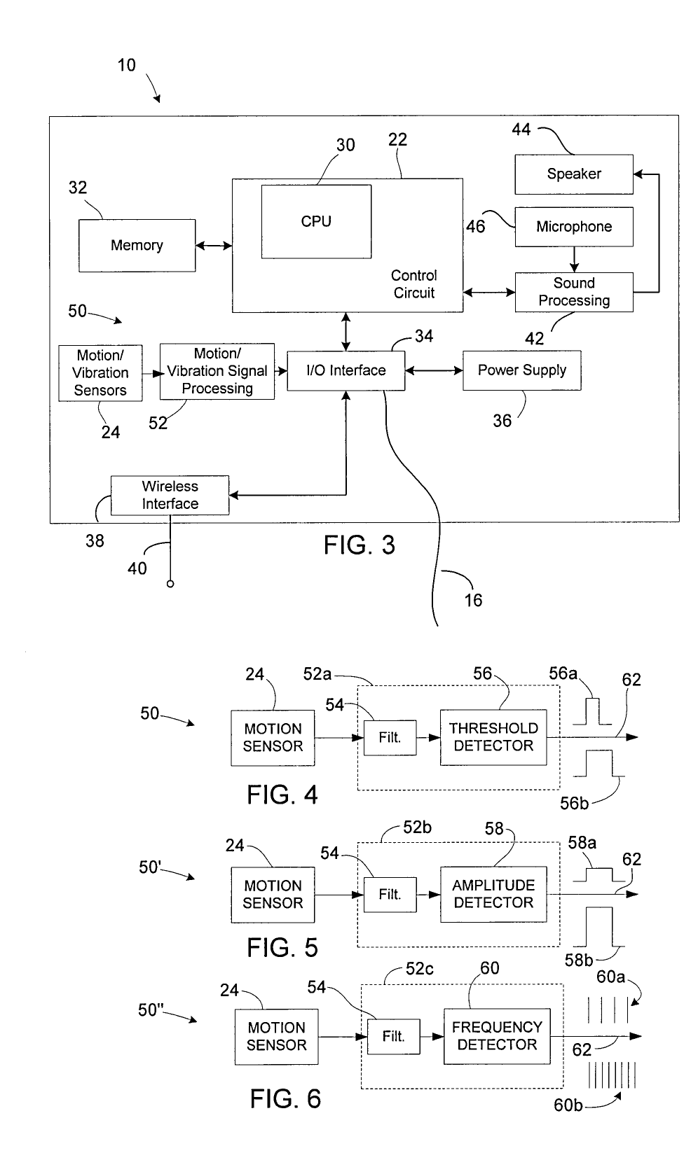

The control circuit 22 can comprise a processor and associated input/output (I/O) circuitry (e.g., analog and/or digital I/O, serial communication channels, etc.), memory, etc. as described in more detail below with respect to FIG. 3. The transducers 24a and 24b can be a motion or vibration sensor, for example, that detects motion and/or vibration of the respective ear piece. Further, the control circuit 22, for each transducer 24a and 24b, can have stored in memory a number of predefined signals and commands associated with these signals. The predefined signals may contain information regarding the number of signals provided by the transducer, the timing of the signals, which transducer provided the signal, the general waveform of the signal, etc. The associated commands can be any desired command, such as a volume increase or decrease, mute, etc. For example, a single tap to the right ear piece can correspond to a request to increase the volume, while a single tap to the left ear piece can correspond to a request to decrease volume. Simultaneous taps to both the left and right ear pieces can be interpreted as a mute function. As used herein, simultaneous taps to both ear pieces includes taps that occur at the same instant in time or at substantially the same instant in time (e.g., taps that occur within a predefined time period of one another such as 0.2 seconds). Other possible functions include call accept (e.g., double tap to the right ear piece) and call end (e.g., double tap to the left ear piece). As will be appreciated, the headset may be configured for any number of different commands (either preconfigured or user programmable).

In operation, as the left or right ear piece is tapped (e.g., tapped by a user's finger), the respective transducer 24a or 24b detects the resulting motion and/or vibration and generates a corresponding signal, which is provided to the control circuit 22 (e.g., via the I/O circuitry). The control circuit 22 then can interpret the received signal(s) to determine the desired command. More particularly, the control circuit 22 can compare the received signal(s) to the predefined signals stored in memory of the headset 10 (e.g., compare (e.g., the number of taps, timing, etc.). Based on which transducer provided the signal and which predefined signal corresponds to the received signal, the control circuit 22 can retrieve from memory the command associated with the corresponding predefined signal and act on the command (e.g., provide the command to the mobile phone or act on the command within the headset).

In another embodiment, the transducer is operable to detect a rotation of the headset, and this detected rotation can be provided to the control circuit 22. Based on this detected rotation, the control circuit 22 can generate a command so as to carry out a desired operation. For example, rotation in a first direction may be equated to a volume increase, and rotation in a second direction may be equated to a volume decrease. If the headset is quickly rotated in the first direction, the transducer 24 can generate a signal corresponding to such rotation. The control circuit 22 then can interpret the rotation and increase the volume. Similarly, if the headset is quickly rotated in a second (e.g., opposite) direction, the transducer can generate a signal corresponding to this rotation. The control circuit then can interpret the signal and decrease the volume. Preferably, casual or incidental rotation of the headset is not acted on by the control circuit 22.

With continued reference to FIG. 2, the transducer 24 may be implemented using an accelerometer 24′, an exemplary functional block diagram of which is shown in FIG. 2. Operation of accelerometers is well known and thus will not be described in detail herein. Briefly, an accelerometer measures the acceleration it experiences, expressed in g's. Accelerometers may be embodied as micro electromechanical systems (MEMS) that include a cantilever beam with a proof mass (also known as seismic mass) and deflection sensing circuitry. Under the influence of acceleration the proof mass deflects from its neutral position. The deflection is measured in an analog or digital manner. Another type of MEMS-based accelerometer contains a small heater at the bottom of a very small dome, which heats the air inside the dome to cause it to rise. A thermocouple on the dome determines where the heated air reaches the dome and the deflection off the center is a measure of the acceleration applied to the sensor.

The exemplary accelerometer 24′ of FIG. 2 may be embodied as a surface-micromachined polysilicon structure formed on a silicon wafer. In this exemplary accelerometer, springs formed from polysilicon suspend the structure over the surface of the wafer and provide resistance against acceleration forces. A differential capacitor (e.g., a capacitor that includes independent fixed plates and plates attached to the moving mass) is used to measure the deflection of the structure, and the fixed plates are drive by 180 degrees out-of-phase square waves. During acceleration, the beam is deflected and this unbalances the differential capacitor, resulting in an output square wave that is proportional to acceleration. The signal is rectified using phase-sensitive demodulation techniques, for example, so as to determine the direction of the acceleration. The output of the demodulator is amplified and brought off-chip through a resistor.

Moving now to FIG. 3, there is shown a functional block diagram of an exemplary headset 10 in accordance with the invention. For the sake of brevity, generally conventional features of the headset 10 will not be described in great detail herein. The headset 10 includes the above-referenced control circuit 22 that is configured to carry out overall control of the functions and operations of the headset 10. The control circuit 22 may include a processing device 30, such as a CPU, microcontroller or microprocessor. The processing device 30 executes code stored in a memory (not shown) within the control circuit 22 and/or in a separate memory, such as the memory 32, in order to carry out operation of the accessory 10. The memory 32 may be, for example, one or more of a buffer, a flash memory, a volatile memory, a non-volatile memory, a random access memory (RAM), or other suitable device.

In addition, the processing device 30 may execute code that implements the functions of the accessory 10 as described herein. It will be apparent to a person having ordinary skill in the art of computer programming, and specifically in application programming for mobile telephones, accessories or other electronic devices, how to program an accessory 10 to operate and carry out logical functions associated with the accessory as described herein. Accordingly, details as to specific programming code have been left out for the sake of brevity. Also, while the accessory functions are executed by the processing device 30 in accordance with a preferred embodiment of the invention, such functionality could also be carried out via dedicated hardware, firmware, software, or combinations thereof, without departing from the scope of the invention.

The accessory 10 may further include one or more I/O interface(s) 34 for providing data to/from the control circuit 22. The I/O interface 34 may include high speed data communication capabilities (e.g., high speed serial communication capabilities), power interface circuits, as well as analog and digital I/O circuits. A power supply 36, such as a battery or the like, provides power to the accessory 10 and its associated components. Conductors 16 coupled to the I/O interface(s) 34 provide a means for communicating data to/from the headset 10 (e.g., via electrical signals, etc.).

The accessory 10 may include a wireless interface 38 and antenna 40 (e.g., if the accessory is a wireless accessory). The wireless interface 38 may include an infrared transceiver and/or an RF interface (e.g., a Bluetooth interface) for establishing communication with an electronic device, such as a mobile phone, a computer or another device. For example, the wireless interface 38 may operatively couple the accessory 10 to a mobile phone 18 in an embodiment where the mobile phone has a corresponding wireless interface so as to exchange information therebetween.

The accessory 10 further includes a sound signal processing circuit 42 for processing audio signals communicated to the control circuit 22 by the conductors 16 and/or the wireless interface 38. Coupled to the sound processing circuit 42 are a speaker 44 and a microphone 46 that enable a user to listen and speak via the accessory 10 as is conventional. Audio data may be passed from the control circuit 22 to the sound signal processing circuit 42 for playback to the user. The sound processing circuit 42 may include any appropriate buffers, decoders, amplifiers and so forth.

The accessory also includes the above-referenced transducer(s) 24, which may be part of a motion and/or vibration sensor 50 for detecting motion and/or vibration of at least a portion of the headset 10. As discussed above, this motion and/or vibration can be used to provide control signals to other devices, such as a mobile phone, for example. The motion and/or vibration sensor 50 may also include a motion and/or vibration signal processor 52 for conditioning signals provided by the transducer, as described in more detail below.

With further reference to FIGS. 4, 5 and 6, several examples of motion and/or vibration sensors 50, 50′ and 50″ are illustrated. The motion and/or vibration sensor 50 shown in FIG. 4 comprises a transducer 24 embodied as an accelerometer. The sensor 50 also may include signal processing circuitry, for example, motion and/or vibration signal processing circuit 52, which is described below. The accelerometer 24′ of the sensor 50 may provide a signal output, e.g., an electrical signal, representing acceleration or vibration of the transducer. The accelerometer 24′ may be in each ear piece 12 of the accessory 10, and is useful to produce signals representing motion occurring as the accessory is tapped or rotated.

It will be appreciated that a motion and/or vibration sensor 50 may be any device, circuit or other mechanism or combination thereof that provides an indication that motion and/or vibration has been sensed and/or provides an indication of the character of the motion and/or vibration (e.g., acceleration, velocity, direction, directional change, rotation, or any other characterization of the motion and/or vibration). An example, as is mentioned above, is a sensor 50 that uses an accelerometer 24′ that provides an electrical output (or some other output) in response to acceleration. Another example is sensor 50 that uses a velocimeter that provides an output representative of velocity. Still another example is a sensor 50 that uses a signal detector that responds to changes in electrical signals, radio frequency signals, or some other signals, such as amplitude or frequency or changes therein, or some other discernible change that occurs due to motion or vibration.

The exemplary motion and/or vibration sensor 50, as is shown in respective embodiments of FIGS. 4, 5 and 6, also includes the motion and/or vibration signal processing circuit, which is designated generically 52 in FIG. 3 and is designated individually 52a, 52b, 52c, respectively, in FIGS. 4, 5 and 6. The transducer 24 of the sensor 50 produces an output indicative of motion and/or vibration of the accessory 10. This output is provided to the motion and/or vibration signal processing circuit 52, which processes and conditions the signal prior to being input to the control circuit 22. For example, the motion and/or vibration signal processing circuit 52 provides a motion and/or vibration signal to the control circuit 22 to indicate at least one of that motion and/or vibration has been detected, characteristics of that motion and/or vibration, e.g., duration of the motion/vibration, amplitude of the motion/vibration, frequency (e.g., changes of direction) of the motion/vibration, etc. and/or that motion/vibration has ceased. The motion and/or vibration signal processing circuit 52 may filter the output of the transducer 24 or otherwise may condition the output using known techniques such that the indication of motion/vibration or an appropriate signal to represent motion/vibration to the control circuit 22 only is provided in instances where appreciable movement and/or vibration (e.g., exceeding a predetermined threshold, duration, frequency) is detected. Such motion and/or vibration is referred to as intended motion/vibration. The motion and/or vibration signal processing circuit 52 may block from the control circuit 22 signals representing brief or casual movement of the accessory 10, e.g., a dead zone where slight movement of the accessory, such as a result of being handled by a stationary user, and/or vibration associated with sounds produced by the accessory, is/are not registered as an intended motion/vibration. Therefore, the motion and/or vibration signal processing circuit 52 preferably requires that the output from the transducer 24 be maintained for at least a predetermined time, amplitude and/or frequency prior to issuing a motion/vibration indication, e.g., that intended motion/vibration has been detected, to the control circuit 22. Alternatively, the output of the transducer 24 may be directly provided to the control circuit 22 and the control circuit 22 may include appropriate circuitry and/or program code to effect the desired filtering, e.g., as was just described, to avoid false indications of motion/vibration detection of a type that would result in unnecessary control actions, for example.

With the above in mind, then, each of the exemplary motion and/or vibration signal processing circuits 52a, 52b, 52c shown in FIGS. 4, 5 and 6 includes a filter 54 and either a threshold detector 56, amplitude detector 58 or frequency detector 60. In an another embodiment the motion and/or vibration signal processing circuit 52 may include a combination of two or more of the detectors 56, 58, 60. The filter 54 removes or blocks signals representing casual motion, vibration, noise or spurious signals representing brief, unintended movement or vibration of the accessory 10, or casual movement or vibration of the accessory, such as may occur during handling of the accessory. The threshold detector 56 is designed to output an appropriate motion and/or vibration signal on line 62, which is coupled as an input to the control circuit 22, when motion and/or vibration of a relatively long duration occurs, e.g., probably not due to casual motion, noise or the like. The threshold detected by the threshold detector 56 may be represented by pulse width of signals input thereto, and the output therefrom may be representative of such pulse width, as is represented by the relatively short and long pulse width signals 56a, 56b. The signal provided on line 62 to the control circuit 22 may be of a shape, form, duration, etc., similar to the signals 56a, 56b, may be respective high or low signals, depending on the duration of the signals 56a, 56b, may be a digital signal value of a prescribed number of data bits in length, or may be of some other character that is suitable to effect a desired operation of the control circuit 22 depending on whether or not intended motion and/or vibration has been detected. As several examples, the cutoff or distinguishing duration of pulse widths representing the motion and/or vibration detected to distinguish between intended motion/vibration and casual motion/vibration or noise may be about a fraction of a second (e.g., up to 0.2 seconds per tap); this is just exemplary and the duration or pulse width of occurrence of such motion may be more or less.

As another example of motion and/or vibration signal processing circuit 52b, there is illustrated in FIG. 5 a filter 54 and an amplitude detector 58. The amplitude detector 58 provides an output on line 62, e.g., of a type suitable for the control circuit 22 to understand and to operate based on whether intended or prescribed motion and/or vibration has been detected or has not been detected. For example, casual motion, vibration, or noise may produce a relatively low amplitude signal 58a as input or output from the amplitude detector; and intended or prescribed motion may produce a relatively larger amplitude signal 58b as input or output to/from the amplitude detector 58.

Still another example of motion and/or vibration signal processing circuit 52c is illustrated in FIG. 6 as a filter 54 and a frequency detector 60. The frequency detector 60 provides an output on line 62, e.g., of a type suitable for the control circuit 22 to understand and to operate based on whether intended or prescribed motion/vibration has been detected or has not been detected. For example, casual motion or noise may produce a relatively low frequency signal 60a or respond to a relatively low frequency signal 60a, respectively, as output from or input to the amplitude detector. A relatively higher frequency signal 60b input to and/or output from the frequency detector 60 representing detection of intended motion, for example, may be provided to the control circuit 22.

To increase the accuracy in which the accessory 10 interprets the requested user commands, two different types of sensors may be utilized. For example, each ear piece 12a and 12b may include both a motion sensor and a vibration sensor. The data from these two sensors then can be analyzed together to further improve the performance of the accessory. Then, only when the analysis from both sensors yields the same conclusion will a command be issued. In this manner, the likelihood of false signals can be further reduced.

For example, if the right ear 12b piece is tapped two times (which in the present example represents a “call accept” command), both the motion sensor and the vibration sensor should detect these two taps. The control circuit 22 can compare the signal from each transducer to determine if they are in agreement (e.g., two distinct taps were detected on the right ear piece). If they agree, then the command (i.e., call accept) is executed. If they do not agree (e.g., the motion sensor detected two taps, but the vibration sensor detected one tap), then no command is executed as the two sensors are in disagreement.

When using a vibration sensor (either alone or in combination with a motion sensor) in the ear piece, care must be taken to ensure that vibrations resulting from normal use of the headset do not result in signals that may be interpreted as a user command. This may be accomplished, for example, by insulating the vibration sensor from sounds produced by the ear piece and/or tuning/filtering the data from the vibration sensor such that only certain frequencies (and/or amplitudes) are identified as a valid signal (e.g., frequencies corresponding to a user tapping the ear piece).

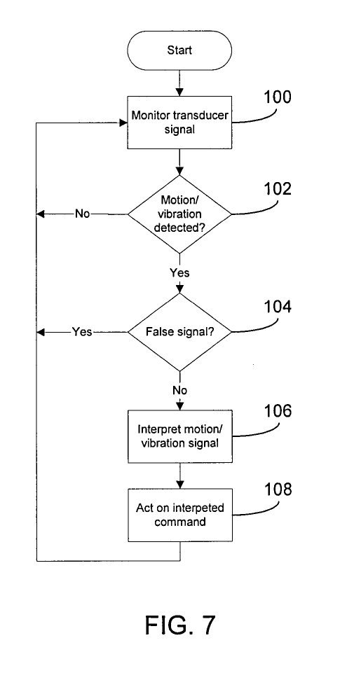

With additional reference to FIG. 7, illustrated are logical operations to implement an exemplary method of controlling a buttonless accessory and/or providing control signals from a buttonless accessory to an electronic device. Although FIG. 7 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the accessory control function in accordance with the invention may begin at block 100 where the signal provided by the transducer 24 is monitored. At block 102, it is determined from the signal if motion and/or vibration is detected. For example, if a signal is not provided by the transducer 24, then it can be concluded that there is no motion and/or vibration at the accessory 10. In this instance, the method moves back to block 100 and repeats. However, if a signal is provided by the transducer 24, then at block 104 it is determined if the motion and/or vibration is due to intended motion and/or vibration, or is simply a false signal.

For example, some signals provided by the transducer 24 may not be a result of intended motion/vibration. These signals can be filtered or otherwise removed from the signal provided to the control circuit 22 (e.g., by the signal processing circuit 52). In this manner, even though a signal was generated by the transducer 24, the control circuit 22 will not issue a command. Only when it is determined that the signal corresponds to intended motion or vibration does the control circuit 22 issue a corresponding command to the electronic device 18 and/or to portions of the accessory itself. Thus, if it is determined that the signal is a false signal, the method moves back to block 100. Otherwise, the motion and/or vibration signal is interpreted at block 106.

More particularly, the control circuitry 22 first determines which ear piece 12 provided the motion or vibration signal. This can be determined, for example, based on known addressing and/or dedicated I/O locations for the signals provided by the respective transducers. Next, the control circuitry 22 analyzes the signals to determine the number of times each ear piece was tapped, and the relative timing of the taps. For example, if both ear pieces were tapped one time within a fraction of a second of each other (e.g. within 0.2 seconds), then it can be concluded that they were simultaneously tapped. Longer delays may be interpreted as non-simultaneous taps. The control circuitry 22 then compares the originating transducer, the signal combinations and the relative delays of the signals to predefined signal patterns stored in memory 32 of the accessory 10. When a match is found, the command associated with the predefined signal pattern is retrieved from memory.

At block 108 the command is executed. For example, if the command is a mute command, then the control circuit 22 may instruct the sound processing circuit 42 to cease all sound output. Other commands may be communicated to the electronic device 18. For example, if the command is a volume increase or decrease command, then such command is communicated to the electronic device 18 via the conductors 16 and/or via the wireless interface 38. Once received, the electronic device 18 then can proceed to act on the command (e.g., increase or decrease the volume, answer/end a call, etc.).

A person having ordinary skill in the art of computer programming and applications of programming for mobile phones would be able in view of the description provided herein to program an accessory 10 to operate and to carry out the functions described herein. Accordingly, details as to the specific programming code have been omitted for the sake of brevity. Also, while software in the memory 32 or in some other memory of the accessory 10 may be used to allow the accessory to carry out the functions and features described herein in accordance with the preferred embodiment of the invention, such functions and features also could be carried out via dedicated hardware, firmware, software, or combinations thereof, without departing from the scope of the invention.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A headset for an electronic device, comprising:
an audio output device including a left ear piece and a right ear piece;
a plurality of transducers each operable to provide a signal corresponding to at least one of motion or vibration of at least a portion of the headset, wherein one transducer of the plurality of transducers is associated with the left ear piece and another transducer of the plurality of transducers is associated with the right ear piece; and
circuitry operatively coupled to the plurality of transducers, wherein the circuitry is configured to generate a control signal for use by the headset or the electronic device based on the respective signals.

2. The headset according to claim 1, further comprising:
a memory;
a plurality of different signals stored in the memory; and
a plurality of different commands stored in the memory, wherein each of the plurality of different signals is associated with one of the plurality of commands.

3. The headset according to claim 2, wherein the circuitry is operative to determine if the respective signals correspond to any of the plurality of signals stored in memory, and to generate the control signal based on the command associated with the corresponding signal.

4. The headset according to claim 1, wherein each of the plurality of transducers comprises
i) a first transducer for generating a first signal corresponding to motion of the portion of the headset and
ii) a second transducer for generating a second signal corresponding to vibration of the portion of the headset.

5. The headset according to claim 4, wherein the circuitry includes signal processing circuitry operatively coupled to the first and second transducers, wherein the signal processing circuitry is configured to
i) determine intended motion from the first signal;
ii) determine intended vibration from the second signal; and
iii) generate the control signal when the intended motion and intended vibration correspond to one another.

6. The headset according to claim 1, wherein the headset is a buttonless headset.

7. The headset according to claim 1, wherein at least one of the transducers comprise an accelerometer.

8. The headset according to claim 1, further comprising a wireless transceiver operative to communicate the control signal between the accessory and the electronic device.

9. The accessory according to claim 1, further comprising a signal processing circuit operatively coupled to each transducer of the plurality of transducers, wherein the signal processing circuit is configured to determine from each signal at least one of intended motion or intended vibration of the portion of the accessory.

10. The headset according to claim 9, wherein the signals correspond to acceleration and/or deceleration of the portion of the accessory along at least one predetermined axis.

11. The headset according to claim 9, the signal processing circuit comprising a signal conditioning circuit to filter out signals that do not meet predetermined criteria.

12. The headset according to claim 9, wherein the signal processing circuit is operative to provide a motion and/or vibration signal indicative of duration of the motion and/or vibration, amplitude of the motion and/or vibration, and/or frequency of the motion and/or vibration.

13. The headset according to claim 1, wherein at least one of the transducers is operable to detect at least one of acceleration, position, or rotation of the portion of the accessory.

14. A system for providing audio to a user, comprising
the headset according to claim 1; and
the electronic device.

15. A method for controlling an electronic device from an accessory, said accessory including at least one transducer operable to provide a first signal indicative of at least one of motion or vibration of at least a portion of said accessory, comprising:
storing in memory a plurality of predefined signals and corresponding commands;
comparing the first signal from the at least one transducer with the predefined signals stored in memory; and
upon the first signal corresponding to one predefined signal of the plurality of predefined signals, executing the command associated with the corresponding predefined signal.

16. The method according to claim 15, wherein the at least one transducer comprises a first transducer operative to detect motion of the portion of the accessory, and a second transducer operative to detect vibration of the portion of the accessory, further comprising executing the command when a first signal from the first transducer and a second signal from the second transducer are determined to be in agreement.

17. The method according to claim 15, further comprising tapping on a portion of the accessory to generate the first signal.

18. The method according to claim 15, wherein executing the command includes executing at least one of a volume increase, a volume decrease, a mute, a call accept or a call end.

19. The method according to claim 15, wherein executing the command includes communicating the command associated with the corresponding predefined signal to the electronic device via a wired or wireless interface.

20. The method according to claim 15, further comprising performing signal conditioning on the first signal to filter out signals that do not meet a predetermined criteria.

21. An accessory for an electronic device, comprising:
a memory;
a plurality of different signals stored in the memory;
a plurality of different commands stored in the memory, wherein each of the plurality of different signals is associated with one of the plurality of commands;
at least one transducer operable to provide a first signal corresponding to at least one of motion or vibration of at least a portion of the accessory; and
circuitry operatively coupled to the transducer, wherein the circuitry is configured to generate a control signal for use by the accessory or the electronic device based on the first signal.
